(19) United States
(12) Patent Application Publication
(10) Pub. No.: US 2026/0355065 A1
(43) Pub. Date: Nov. 12, 2026

(54) FEEDING BOTTLE

(71) Applicant: CARAMMA APS, Kobenhavn SV (DK)

(72) Inventors: Monika Havno, Kobenhavn (DK); Rie Maktabi Grue, Kobenhavn (DK)

(21) Appl. No.: 19/488,700

(22) PCT Filed: May 31, 2024
(86) PCT No.: PCT/EP2024/064984

§ 371 Date: Nov. 28, 2025

(30) Foreign Application Priority Data
May 31, 2023 (DK) PA202330053

(51) Int. Cl. A61J 11/04; A61J 9/00

(52) U.S. Cl. CPC A61J 11/045; A61J 9/005

(57) ABSTRACT

A feeding bottle includes
a container (2) having an opening for liquid (2a),
a teat (7) having an inlet and outlet for liquid (7a), and
a coupling device (8) fixing the teat (7) to the container (2) during use,
the container includes a first compartment (3) with inner surfaces (11) of walls that during emptying give in thereby reducing the volume of the first compartment (3) that has a first part (12) having the opening for liquid (2a) and a second part (13) having a bottom section (14) adjoined to the first part along a periphery, during emptying, the second part (13) is displaceable into a volume formed by the first part (12), and the bottom section (14) is displaceable in direction along a longitudinal axis I of the feeding bottle (1), from a position opposite the opening (2a) to a position adjacent to the opening (2a).

[symbol] [symbol] [symbol] [symbol] [symbol] [symbol] [symbol] [symbol] A stretchy nursing bottle

The present invention relates to a stretch bottle, and more particularly, a body into which the sterilization pack is inserted is formed of a plurality of transfer tubes, and they are interleaved and configured to stretch the stretch bottle.

1 is a cross-sectional view showing a state in which a sterilization pack is embedded as a bottle to which a conventional technique is applied.

Generally, when going out with an infant, a plurality of feeding bottles are provided. In order to reduce such inconvenience, a single feeding bottle 10 and a plurality of sterilizing packs S accommodated inside the feeding bottle 10 are provided. There are many.

Looking at the bottle 10, the container-shaped body 30 formed vertically long to accommodate the long formed sterilization pack(S), and protrudes in succession to the upper body 30 to the inner side so that the feeding cap 20 is fastened Or the protruding pipe 37 in which the screw part R was formed in the outer side is formed.

The nursing cap 20 is inserted into the nursing tap 25 to be sucked into the mouth of the infant is formed with a hole (H) is configured to discharge the milk through the hole (H).

In order to use the bottle 10, first, the sterilization pack (S) is to be accommodated in the interior of the body 30 and the upper open portion so as to span the protruding tube (37). Then, after injecting water and powdered milk into the sterilization pack (S), the feeding cap 20 is to be fastened by the spiral coupling to the protruding pipe (37). At this time, the upper open portion of the sterilization pack (S) is pinched between the projection tube 37 and the feeding cap 20 is fixed.

In this state, the baby bottle 10 is shaken so that water and powdered milk are mixed to supply the prepared milk to the baby.

When it is necessary to feed again after feeding, discard the sterilization pack (S) and use the new sterilization pack (S) to be fixed as described above.

In the case of the bottle according to the prior art, since the body is formed long, it takes up a lot of volume, there was a problem that it is not easy to store in the bag or the like.

Accordingly, in the present invention, in the stretchable bottle in which the sterilization pack is inserted and the protruding tube is formed in the upper portion of the body, the body is composed of a plurality of transfer tubes to be stretchable, and the transfer tubes are in turn smaller or larger in width. It is formed in a fork is formed in turn, the bottom of the transfer pipe is formed in the bottom of the transfer pipe is closed is formed, the projections formed so as to catch each other on the mutually opposing surfaces of each of the transfer pipe is formed.

According to the present invention, in the feeding bottle is inserted into the body and the sterilization pack is formed in the extension tube, the body can be stretched, the volume is reduced during compression, there is an advantage that it is easy to carry, lactation When elongated, there is an effect that can be used by inserting the sterilization pack.

Hereinafter, with reference to the accompanying drawings, a configuration, an embodiment, and an operation example of the present invention for achieving the above object are as follows.

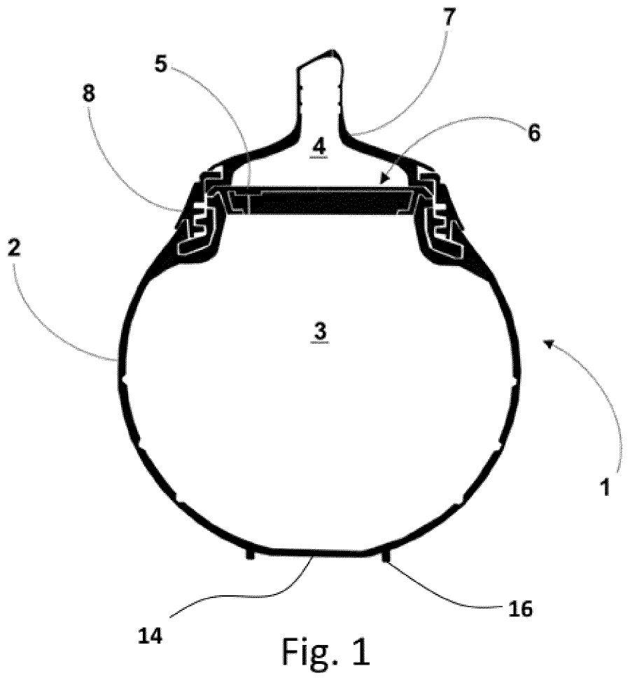

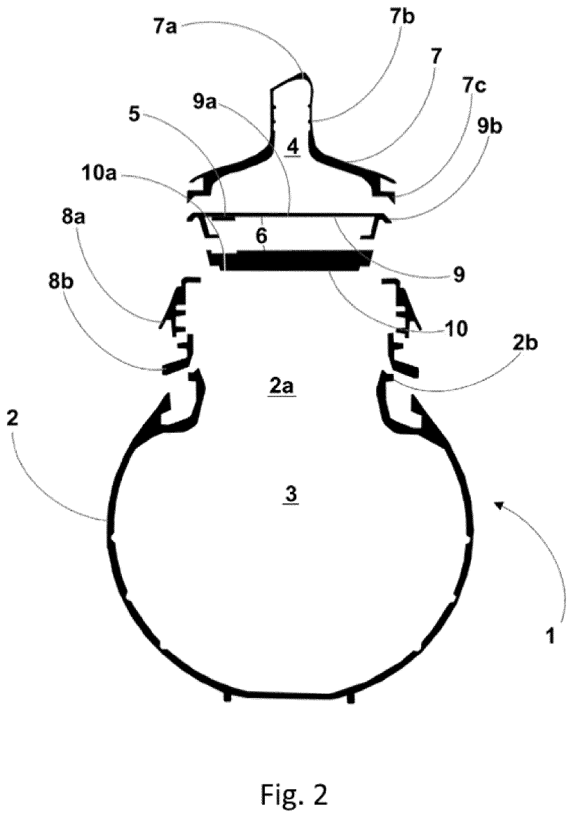

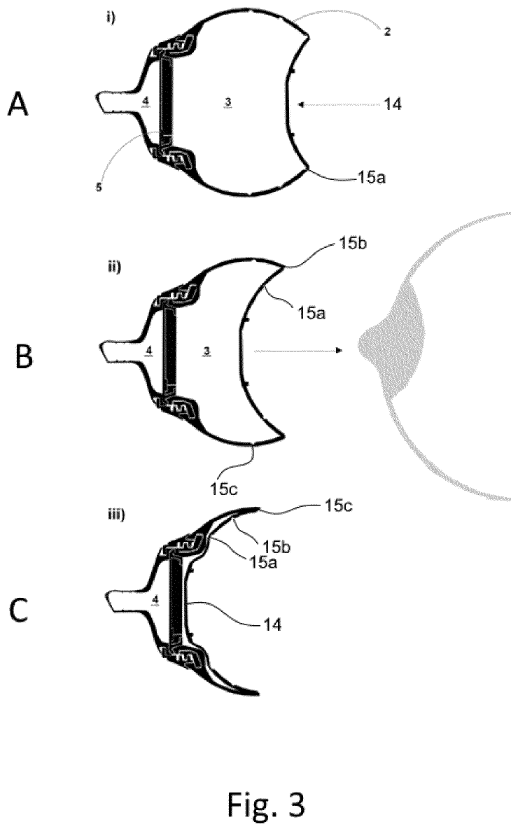

1 is a cross-sectional view showing a state in which a sterilization pack is embedded therein as a bottle applied with a conventional technique, and FIG. 2 shows a first embodiment of a stretch bottle to which the technique of the present invention is applied. 3 is a cross-sectional view showing a state in which the sterilization pack is inserted, FIG. 3 is a cross-sectional view showing part A of FIG. 2, and FIG. 4 is a cross-sectional view showing a compressed state as a first embodiment of a stretchable bottle to which the technique of the present invention is applied. 5 is a cross-sectional view showing a first embodiment of a stretchable bottle to which the technique of the present invention is applied, in which a receiving groove is formed and stacked in a transport tube at the bottom thereof, and FIG. 6 is a stretch to which the technique of the present invention is applied. A cross-sectional view showing the first embodiment of the feeding bottle as configured so that the upper transfer pipe is configured to be inserted into the lower transfer pipe, and FIG. 7 shows a second embodiment of the stretchable bottle to which the technique of the present invention is applied. Done FIG. 8 is a cross-sectional view showing a state in which the sterilization pack is embedded in the state, FIG. 8 is a cross-sectional view showing a compressed state as a second embodiment of the stretchable bottle to which the technique of the present invention is applied, FIG. 9 is a technique of the present invention The second embodiment of the applied feeding bottle is described as a cross-sectional view showing that the upper transfer pipe is configured to be inserted into the lower transfer pipe.

Generally, when going out with an infant, a plurality of feeding bottles are provided. In order to reduce the inconvenience, a single feeding bottle 100 and a plurality of sterilizing packs S accommodated inside the feeding bottle 100 are provided..

Looking at the bottle 100, the body 120 of the container shape is formed vertically long to accommodate the sterilized pack (S) formed long, and protrudes in succession to the upper portion of the body 120 to the inner side to fasten the feeding cap 110 Or the protrusion pipe 123 in which the screw part R is formed in the outer side is comprised.

The nursing cap 110 is inserted so that the feeding nipple 115 that is bitten by the infant's mouth is upwardly exposed, and the user buys it separately and uses it by fastening it to the feeding bottle 100.

In the present invention, it is possible to expand and contract the body 120 is characterized in that it is configured for easy portability.

To this end, the present invention is configured as follows.

First, referring to the first embodiment, the body 120 is composed of a plurality of transfer pipes 123 to be stretchable, as shown in FIGS. 2 to 4, the transfer pipes 121, 123, 125 are sequentially width It is formed so as to be smaller in order to be accommodated in the lower feed pipe (123, 125) is inserted into the upper feed pipe (121, 123), or as shown in FIG. 5 the width of the feed pipe (121, 123, 125) sequentially It is formed so as to be in turn so that the upper transfer pipes 121 and 123 are inserted into and accommodated in the lower transfer pipes 123 and 125. In addition, the lowermost transport pipe (125) is formed so that the lower end is blocked so that the sterilization pack (S) is not exposed, the upper transport pipe (121) is a protruding pipe fastening cap (110) at the top (123 is formed.

Protrusions 127 and 129 are formed on the mutually opposing surfaces P and Q of the transfer pipes 121, 123 and 125 so as to prevent their separation. For example, in the case of FIGS. 2 to 4, the projection 129 is formed below the inner side of the transfer pipes 121 and 123, and the projection 127 is formed above the outer side of the transfer pipes 123 and 125. When extending (121, 123, 125) is configured to prevent the departure by the projections (127, 129).

In the above, the projection 127 is not formed above the outer surface of the uppermost transport pipe 121, and the projection 129 is not formed below the inner surface of the transport pipe 125 of the lowermost location.

At this time, one side of the protrusions 127 and 129 that are caught and opposed may be formed to be inclined in the protruding direction from the upper side to the lower side as shown in FIG. 3 to maintain the extended state in the state in which the opposite side protrusion 127 is pinched. Of course, when the force is applied in the contraction direction, the pinched state of the projections 127 and 129 is released.

The inclined protrusion 129 is formed above the outer surfaces of the transfer pipes 123 and 125, and is formed to be inclined in the protruding direction from below to the upper side, and the opposite side protrusion 127 in contact with the protrusion 129 is an inner side surface. Of course, if formed below it works the same.

In the bottom of the transfer pipe 125, as shown in FIG. 5 is formed in the lower surface receiving groove (T) is fitted with the projection tube 123 may be composed of a plurality of bodies 120 are stacked downward. Therefore, a large number can be easily carried by putting it in the case in the laminated state.

As another example, in the case of FIG. 6, projections 129 are formed above the inner surfaces of the transfer pipes 121 and 123, and projections 127 are formed below the outer surfaces, thereby preventing deviation in the extension direction. In addition, the protrusion 129 formed below is also inclined in the protruding direction from above to downward, and when a force is applied in the stretching direction, the opposite side protrusion 127 is caught by the inclined protrusion 129 to extend the state. Will be maintained.

In the above, the uppermost transfer pipe 121 has no protrusion 127 formed on the inner side of the upper transfer pipe 121, and the protrusion 129 is not formed below the outer side of the bottom transfer pipe 125.

The inclined protrusion 129 is formed above the inner surface of the transfer pipe 123, and the opposite side protrusion 127 in contact with the protrusion 129 operates the same even if formed below the outer surface.

Even in this case, the lowermost transfer pipe 125 may have a receiving groove (not shown) in which a protrusion pipe 123 is fitted on a lower surface thereof, such that a plurality of bodies 120 are stacked downward. Therefore, it can be carried in a case in a laminated state and carried.

Next, the configuration of the second embodiment will be described.

The body 120 is composed of a plurality of transfer pipes 123, the transfer pipe 123 is formed to be smaller or larger in width sequentially so that each transfer pipe (121, 123, 125) is the next transfer pipe 123, 125 is configured to accommodate or fit, the bottom of the transfer pipe (121, 123, 125) of the bottom transfer pipe 125 is configured to be closed, the transfer pipe (121, 123, 125) is separated Tapered to prevent.

For example, as shown in FIGS. 6 to 8, in each of the transfer pipes 121, 123, and 125, the taper is formed to be tapered so that the width of the lower portion is smaller than the width of the upper portion, or as shown in FIG. 9, the width of the lower portion is larger than the width of the upper portion. The taper is formed to be tapered so that the lower transfer pipes 123 and 125 are caught by the upper transfer pipes 121 and 123 at the time of stretching, and the separation is prevented. It becomes pinched in contact with (P, Q), and it is possible to maintain the extended state. Of course, if a force is applied in the compression direction, the pinched state of the surfaces P and Q is released.

In addition, the lowermost transfer pipe 125 may have a receiving groove (not shown) in which the protrusion pipe 123 is fitted on a lower surface thereof, and thus, a plurality of bodies 120 may be stacked downward. Therefore, it can be carried in a case in a laminated state and carried.

Looking at the use of the present invention by the above configuration as follows.

When the body 120 is compressed, each of the transfer pipes 121, 123, and 125 is contracted while being inscribed in order to reduce the volume. Therefore, it can be easily carried with the sterilization pack (S).

At the time of feeding, it is easily elongated when it is extended by holding the uppermost transfer pipe 121 and the lowermost transfer pipe 125 among the transfer pipes 121, 123, and 125 constituting the body 120. Put the sterilization pack (S) in the interior of the body 120, after putting water and milk powder in the sterilization pack (S), the feeding cap 110 is fastened to the protruding tube 123 to feed the infant.

1 is a cross-sectional view showing a state in which the sterilization pack is embedded therein as a bottle to which the prior art is applied.

FIG. 2 is a cross-sectional view showing a state in which the sterilization pack is embedded in the stretched state as showing a first embodiment of the stretchable bottle to which the technique of the present invention is applied.

3 is a cross-sectional view of a portion a of FIG.

FIG. 4 is a cross-sectional view showing a compressed state as showing a first embodiment of the stretchable bottle to which the technique of the present invention is applied.

FIG. 5 is a cross-sectional view showing the first embodiment of the stretchable bottle to which the technique of the present invention is applied, the receiving groove is formed and stacked in the transport pipe at the bottom.

FIG. 6 is a cross-sectional view showing a first embodiment of the stretch bottle to which the technique of the present invention is applied, the upper transfer pipe is configured to be inserted into the lower transfer pipe.

FIG. 7 is a cross-sectional view showing a state in which the sterilization pack embedded in the stretched state as showing a second embodiment of the stretchable bottle to which the technique of the present invention is applied.

8 is a sectional view showing a compressed state as showing a second embodiment of the stretchable bottle to which the technique of the present invention is applied.

FIG. 9 is a cross-sectional view showing a second embodiment of the stretchable bottle to which the technique of the present invention is applied, the upper transfer pipe is configured to be inserted into the lower transfer pipe.

### DESCRIPTION OF THE SYMBOLS USED IN THE MAIN PARTS OF THE DRAWINGS

120: body
121, 123, 125: transfer pipe
127, 129: projection

1. A feeding bottle (1) comprising
a container (2) comprising an opening for liquid (2a),
a teat (7) comprising an inlet for liquid and an outlet for liquid (7a), and
a coupling device (8) fixing the teat (7) to the container (2) during use,
the container (2) comprises a first compartment (3) defined by inner surfaces (11) of walls of the container (2) which walls during emptying of liquid are configured to give in thereby reducing the volume of the first compartment (3), the first compartment (3) comprises a first part (12) comprising the opening for liquid (2a) and a second part (13) comprising a bottom section (14) adjoined to the first part along a periphery, during emptying, the second part (13) of the first compartment (3) is configured to be displaced into a volume formed by the first part (12) of the first compartment (3), and the bottom section (14) is configured to be displaced in direction along a longitudinal axis I of the feeding bottle (1) and of the container (2), from a position opposite the opening (2a) to a position adjacent to the opening (2a)
characterized in that the bottom section (14) is made of rigid and non-deformable material which is displaced during emptying of the first compartment (3) and not deformed when the volume of the first compartment (3) is reduced.

2. The feeding bottle (3) according to claim 1, wherein the walls of the first part (12) of the first compartment (3) are rigid meaning that the walls are not configured to give in during emptying at a pressure difference p2−p1 normally obtained inside a feeding bottle (1), where p1 is the pressure inside the compartment (3) and p2 is the pressure outside the compartment (3).

3. The feeding bottle according to claim 1, according wherein the second part (13) of the first compartment (3)
either comprises walls of a soft and flexible material being foldable by nature combined with a rigid bottom section,
or comprises walls comprising weakening means (15) allowing the rigid walls to fold in a controlled way at the positioned of the weakening means (15).

4. The feeding bottle (3) according to claim 3, wherein the weakening means (15) are score or folding lines positioned at or along the inner surface (11) of second part (13) of the first compartment (3).

5. The feeding bottle according to claim 1, wherein the first compartment (3) is round i.e. the first compartment (3) has a round perimeter and preferably an at least partly spheric outer surface in a state where the first compartment (3) is filled with liquid.

6. The feeding bottle according to claim 1 that further comprises a membrane system (6) comprising a one-way valve (5) positioned between the first compartment (3) and a second compartment (4) inside the teat (7), the membrane system (6) may comprise two membranes (9, 10).

7. The feeding bottle bottle-according to claim 6, where the one-way valve (5) comprises a first side facing the first compartment (3) of the container (2) and a second side opposite the first side facing the second compartment (4) thereby separating the first compartment (3) from the second compartment (4).

8. The feeding bottle according to claim 1, wherein the teat (7) comprises an internal side facing the second compartment (4), and the teat comprises a securing flange (7c) encircling the opening for liquid (2a).

9. The feeding bottle according to claim 6, wherein the teat (7), the one-way valve (5), and the container (2) are interlocked by a set of complementary engagement elements (8a, 8b).
